(19) United States
(12) Patent Application Publication
(10) Pub. No.: US 2007/0217194 A1
(43) Pub. Date: Sep. 20, 2007

(54) Rotary lamp shield driving device for providing a plurality of beam radiation patterns, and lamp assembly using the same

(75) Inventor: Kyu-Sup Lee, Gyeongsangbuk-do (KR)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: SL Corporation

(21) Appl. No.: 11/704,649

(22) Filed: Feb. 9, 2007

(30) Foreign Application Priority Data
Mar. 17, 2006 (KR) 10-2006-0024877

(51) Int. Cl. F21V 33/00

(52) U.S. Cl. 362/253

(57) ABSTRACT

Disclosed is a lamp assembly that provides various beam radiation pattern to correspond to various driving environments of a vehicle. The lamp assembly includes a lamp, a lamp shield driving device partially blocking light emitted from the lamp to form a beam radiation pattern, a lens forward focusing the blocked light, and a housing receiving the lamp and the lamp shield driving device. The lamp shield driving device includes a cylindrical rotary shield, a mover, and a driving unit. The cylindrical rotary shield includes one or more shield protrusions and a screw cam on a peripheral surface thereof, each of the shield protrusions has a predetermined cutoff pattern, and a screw cam has a predetermined pitch. The mover includes a guide protrusion on an upper surface thereof, and the guide protrusion is engaged with the screw cam. The driving unit linearly moves the mover in an axial direction of the cylindrical rotary shield. The cylindrical rotary shield is rotated due to the linear motion of the mover, so that one of the shield protrusions is activated.

### CROSS REFERENCE TO RELATED APPLICATION

This application claims priority from Korean Patent Application No. 10-2006-24877 filed on Mar. 17, 2006 in the Korean Intellectual Property Office, the disclosure of which is incorporated herein by reference in its entirety.

### BACKGROUND OF THE INVENTION

1. Field of the Invention

The present invention relates to a head lamp for a vehicle, and more particularly, to a lamp assembly that provides various beam radiation patterns so as to correspond to driving conditions of a vehicle.

2. Description of the Related Art

Head lamps referred to as headlights are light devices for shedding light on a forward course of a vehicle. Further, the head lamps need to have an intensity of light as bright as a driver can see obstacles 100 m ahead on a road at night. The standards of the head lamps are different for each country. In particular, a beam radiation direction is varied because it depends on whether people drive on the right (Left Hand Drive) or the left (Right Hand Drive).

In general, head lamps of a LHD (Left Hand Drive) vehicle are adjusted so that a beam is radiated more to the right side of a centerline on a road. Meanwhile, head lamps of a RHD (Right Hand Drive) vehicle are adjusted so that a beam is radiated more to the left side of a centerline on a road. That is, regardless of the Left Hand Drive or Right Hand Drive, the beam of the head light is adjusted so as to be darker at a portion adjacent to the centerline on the road. The beam radiation direction is adjusted as described above to reduce the intensity of light radiated to other drivers in the opposite direction, which has been established by law so that the drivers do not suffer from glare.

Head lamps for a vehicle in the related art provide an invariable illumination pattern to a driver regardless of various road conditions. For this reason, it is not possible to ensure an appropriate visual range for securing the safety while a vehicle runs in the following cases: a case where a vehicle runs at high speed which requires a longer distance of a visual range; a case where a vehicle runs under the environment having a higher intensity of illumination as compared to other roads, for example, in an urban district (in this case, degree of dependence upon the intensity of light is decreased); a case where a vehicle runs in the rain or snow or on a wet road (in this case, since light is reflected by rain, snow or the wet road, the intensity of light radiated to other drivers of vehicles in the opposite direction is increased); a case where a vehicle runs in spite of adverse weather condition, which decrease the visual range.

Accordingly, there is a demand for a technique that provides illumination patterns optimally corresponding to changes of road conditions as compared to an invariable illumination pattern in the related art so that an appropriate visual range is always ensured for safe driving.

### SUMMARY OF THE INVENTION

An object of the present invention is to change illumination patterns so as to optimally correspond to continuous changes of road conditions so that a driver can ensure a visual range that corresponds to various road conditions.

Objects of the present invention are not limited to those mentioned above, and other objects of the present invention will be apparently understood by those skilled in the art through the following description.

According to an aspect of the present invention, there is provided a lamp shield driving device including a cylindrical rotary shield, a mover, and a driving unit. The cylindrical rotary shield includes one or more shield protrusions and a screw cam on a peripheral surface thereof, each of the shield protrusions has a predetermined cutoff pattern, and a screw cam has a predetermined pitch. The mover includes a guide protrusion on an upper surface thereof, and the guide protrusion is engaged with the screw cam. The driving unit linearly moves the mover in an axial direction of the cylindrical rotary shield. The cylindrical rotary shield is rotated due to the linear motion of the mover, so that one of the shield protrusions is activated.

According to another aspect of the present invention, there is provided a lamp assembly including a lamp, a lamp shield driving device partially blocking light emitted from the lamp to form a beam radiation pattern, a lens forward focusing the blocked light, and a housing receiving the lamp and the lamp shield driving device.

The lamp shield driving device includes a cylindrical rotary shield, a mover, and a driving unit. The cylindrical rotary shield includes one or more shield protrusions and a screw cam on a peripheral surface thereof, each of the shield protrusions has a predetermined cutoff pattern, and a screw cam has a predetermined pitch. The mover includes a guide protrusion on an upper surface thereof, and the guide protrusion is engaged with the screw cam. The driving unit linearly moves the mover in an axial direction of the cylindrical rotary shield. The cylindrical rotary shield is rotated due to the linear motion of the mover, so that one of the shield protrusions is activated.

### BRIEF DESCRIPTION OF THE DRAWINGS

The above and other features and advantages of the present invention will become more apparent by describing in detail preferred embodiments thereof with reference to the attached drawings, in which:

FIG. 1 is a view schematically showing the structure of a projection type head lamp;

FIG. 2A is a view showing a beam radiation pattern for class C;

FIG. 2B is a view showing a beam radiation pattern for class V;

FIG. 2C is a view showing a beam radiation pattern for class E;

FIG. 2D is a view showing a beam radiation pattern for class W;

FIG. 3 is a view illustrating the structure and rotation operation of a cylindrical rotary shield;

FIG. 4 is a view of various cutoff patterns corresponding to shield protrusions;

FIG. 5 is an exploded perspective view showing a lamp shield driving device according to an embodiment of the present invention;

FIG. 6 is a plan view of the lamp shield driving device shown in FIG. 5, as seen from above;

FIG. 7 is another perspective view of the lamp shield driving device shown in FIG. 5;

FIG. 8 is a perspective view of the lamp shield driving device shown in FIG. 5 when the lamp shield driving device is completely assembled;

FIG. 9 is a view showing a lamp assembly on which the lamp shield driving device shown in FIG. 8 is mounted; and

FIG. 10 is a perspective view of the lamp assembly shown in FIG. 9, as seen from the rear side of the lamp assembly.

### DESCRIPTION OF THE PREFERRED EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Hereinafter, an embodiment of the present invention will be described in detail with reference to the accompanying drawings.

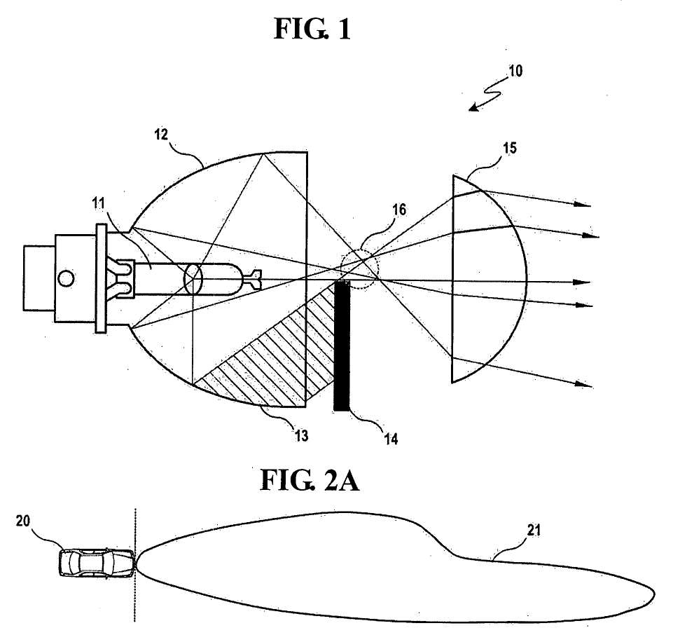

FIG. 1 is a view schematically showing the structure of a projection type head lamp 10. Since the projection type head lamp has a characteristic in which light is focused on one point, the projection type head lamp has an advantage in distributing light as compared to a common clear type head lamp. Further, a vehicle has a sporty shape at the front thereof due to the projection type head lamp.

Light emitted from a light emitting lamp 11 is reflected on a mirror surface 12 having a predetermined shape (for example, oval shape) and then focused on one point 16 in front of the lamp 11. The focused light is refracted by a refractive lens 15 provided on the front side, and is then radiated substantially toward the front side. However, light emitted upward among the emitted light is reflected on the mirror surface 12, and then travels downward. Further, light emitted downward is reflected on the mirror surface 12, and then travels upward. Except for when a high beam is radiated, a shield 14 blocks the light that is emitted downward and travels upward so that other drivers do not feel discomfort.

As described above, according to the projection type head lamp 10, the light reflected on the mirror surface 12 is substantially focused on one point 16 unlike the clear type head lamp. Accordingly, even though the shape of the shield 14 is slightly changed near the one point 16, it is possible to form various beam radiation patterns.

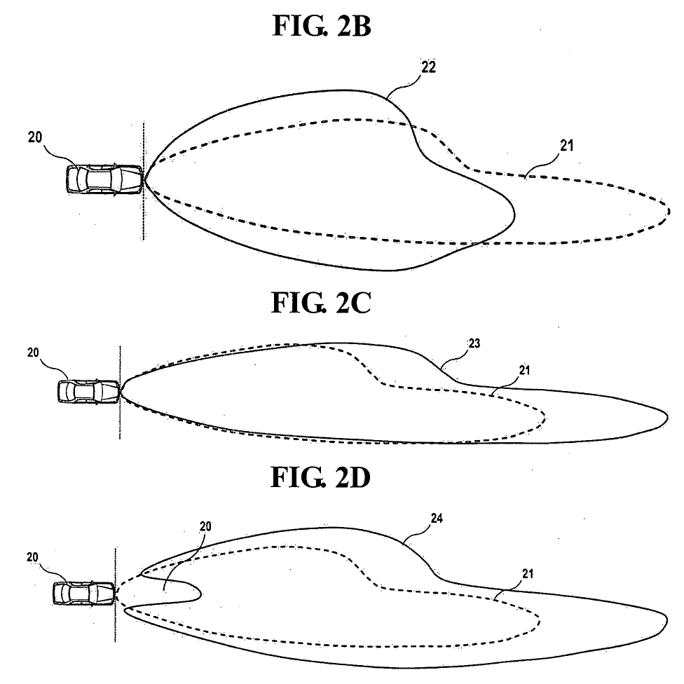

FIGS. 2A to 2D exemplarily show various patterns of beam radiation. FIG. 2A is a view showing a beam radiation pattern for class C. The beam radiation pattern 21 for class C is suitable when a vehicle 20 runs on a country road. The beam radiation pattern 21 for class C ensures a wider visual range on an opposite side of the road and increases the quantity of light thereon as compared to a common low beam.

FIG. 2B shows a beam radiation pattern for class V The beam radiation pattern for class V is suitable when the vehicle 20 runs under the environment having an intensity of illumination to some degree, for example, in an urban district. In particular, the beam radiation pattern for class V ensures a wider visual range in a horizontal direction and a visual range corresponding to a slightly shorter length (about 50 to 60 meters ahead of a vehicle) as compared to the beam radiation pattern 21 for class C. However, generally, each of the left and right head lamps may be commonly tilted outward in general to widen the visual range in the horizontal direction.

FIG. 2C shows a beam radiation pattern for class E. The beam radiation pattern for class E is suitable when the vehicle 20 runs on a substantially straight road. Accordingly, the beam radiation pattern 23 for class E has a longer visual range ahead of a vehicle as compared to the beam radiation pattern 21 for class C.

Finally, FIG. 2D shows a beam radiation pattern for class W. The beam radiation pattern for class W is suitable when the vehicle 20 runs in the rain or on a wet road. Accordingly, the beam radiation pattern for class W has substantially the same visual range ahead of the vehicle as the beam radiation pattern 23 for class E, but has a smaller quantity of light to reduce reflective glare in the range of 10 to 20 m ahead of the vehicle as compared to the beam radiation pattern 23 for class E.

As shown in FIGS. 2A to 2D, the vehicle 20 should actually change the beam radiation pattern so as to correspond to the various driving conditions. In particular, when the projection type head lamp is used in a vehicle, it is advantageous in distributing light. Further, it is possible to easily change the beam radiation pattern in various ways by changing only the shape of the shield. However, since a device for changing a beam radiation pattern in the related art has a complicated configuration, there are problems that manufacturing cost is high and it is difficult to accurately control the shield pattern used to form a predetermined beam radiation pattern.

In consideration of this, the present invention provides a lamp shield driving device, and a head lamp using the lamp shield driving device. The lamp shield driving device includes a cylindrical rotary shield 30 and shield protrusions 31a, 31b, and 31c. The shield protrusions 31a, 31b, and 31c are formed on the surface of the shield 30 at predetermined intervals in a circumferential direction, and selectively operate so as to correspond to the rotation of the shield 30. Accordingly, it is possible to easily use and accurately control the lamp shield driving device by using the shield and the shield protrusions.

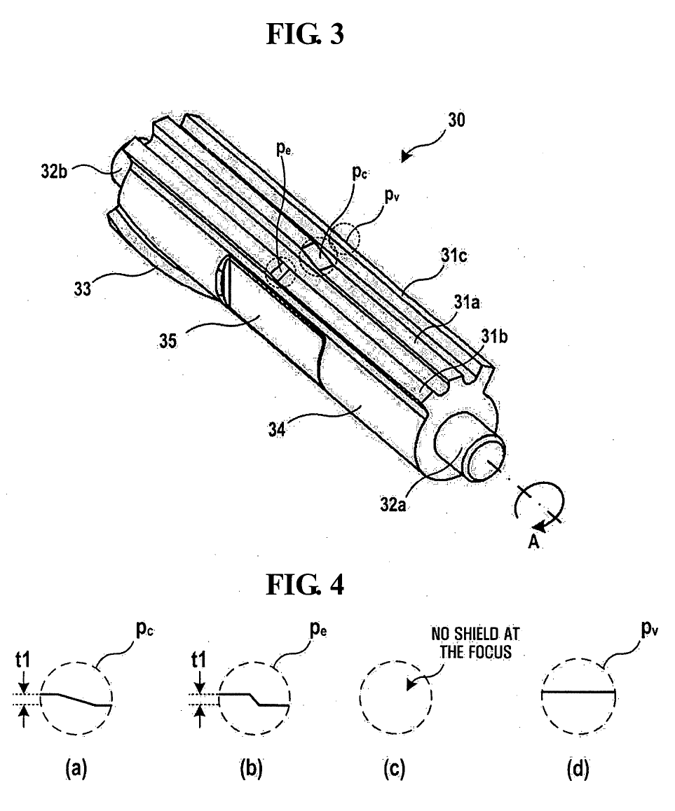

FIG. 3 is a view illustrating the structure and rotation operation of the cylindrical rotary shield 30. Rotary shafts 32a and 32b are formed on both ends of the cylindrical rotary shield 30, and one or more shield protrusions 31a, 31b, and 31c are formed on the peripheral surface of the cylindrical rotary shield 30 in an axial direction thereof. Further, a screw cam 33 for converting a linear motion into a rotational motion is formed on the peripheral surface. Furthermore, a flat portion 35 may be formed on the peripheral surface of the cylindrical rotary shield 30 so as to form a high beam radiation pattern.

First, when the cylindrical rotary shield 30 is positioned at a position (neutral position) shown in FIG. 3, the first shield protrusion 31a of the shield protrusions 31a, 31b, and 31c is positioned at the highest position so as to form the beam radiation pattern for class C. In this specification, an operation that positions any shield protrusion at the highest position and forms a corresponding beam radiation pattern is defined as an “activation” of the shield protrusion.

As described above, the projection lamp has a characteristic in which light is focused on a portion of the projection lamp. Accordingly, the portion on which light is focused is appropriately shielded, so that it is possible to form various beam radiation patterns. According to the embodiment of the present invention, the portion on which light is focused in the projection lamp is an upper middle portion of the cylindrical rotary shield 30.

The shape of a cutoff pattern p_{c} formed on the first shield protrusion 31a is shown in more detail in (A) of FIG. 4. The pattern p_{c} includes two horizontal lines (upper line and lower line), and a line that connects one of the horizontal lines with the other thereof at a first angle. There is a stepped portion having a predetermined height t1 between the two horizontal lines in a vertical direction.

Next, when the cylindrical rotary shield 30 is rotated by a predetermined angle from the position (neutral position) shown in FIG. 3 in a direction of an arrow A, the second shield protrusion 31b of the shield protrusions 31a, 31b, and 31c is positioned at the highest position so as to form the beam radiation pattern for class E.

The shape of a cutoff pattern pₑ formed on the second shield protrusion 31b is shown in more detail in (B) of FIG. 4. The pattern pₑincludes two horizontal lines (upper line and lower line), and a line that connects one of the horizontal lines with the other thereof at a second angle. There may be a stepped portion having the same height t1 as the pattern p_{c} between the two horizontal lines in a vertical direction. That is, it is preferable that the upper line of the pattern p_{c} be flush with the upper line of the pattern pₑ and the lower line of the pattern p_{c} be flush with the lower line of the pattern pₑ. However, the second angle is larger than the first angle to form the beam radiation pattern for class E.

Meanwhile, when the cylindrical rotary shield 30 forms the beam radiation pattern for class E (when the second shield protrusion 31b is positioned at the highest position and the cylindrical rotary shield 30 is then further rotated in the direction of the arrow A, the flat portion 35 is positioned in a horizontal position. In this case, since there is no element for shielding the portion of the projection lamp on which light is focused (see (d) of FIG. 4), it is possible to form the high beam radiation pattern. The flat portion 35 is formed on the peripheral surface of the cylindrical rotary shield in the embodiment of the present invention. However, as long as the portion of the projection lamp on which light is focused is not shielded, the flat portion 35 may not be formed on the peripheral surface of the cylindrical rotary shield.

Finally, the cylindrical rotary shield 30 is rotated by a predetermined angle from the position (neutral position) shown in FIG. 3 in the opposite direction of the arrow A, the third shield protrusion 31c of the shield protrusions 31a, 31b, and 31c is positioned at the highest position so as to form the beam radiation pattern for class C.

The shape of a cutoff pattern pᵥ formed on the third shield protrusion 31c is shown in more detail in (D) of FIG. 4. The pattern pᵥ includes only one horizontal line. However, the pattern pᵥ should shield the larger area as compared to the other patterns p_{c} and pₑso as to form the beam radiation pattern for class V Accordingly, it is preferable that the horizontal line of the pattern pᵥ be flush with the upper line of the pattern p_{c} or pₑ. As a result, the beam radiation distance for class V is shorter than that for class C or E. In addition to this, each of the left and right head lamps may be tilted outward to form a wider viewing angle in the horizontal direction of the vehicle 20. Since the structure for tilting the head lamps in the horizontal direction has been widely known in several related arts, the structure will be omitted in this specification.

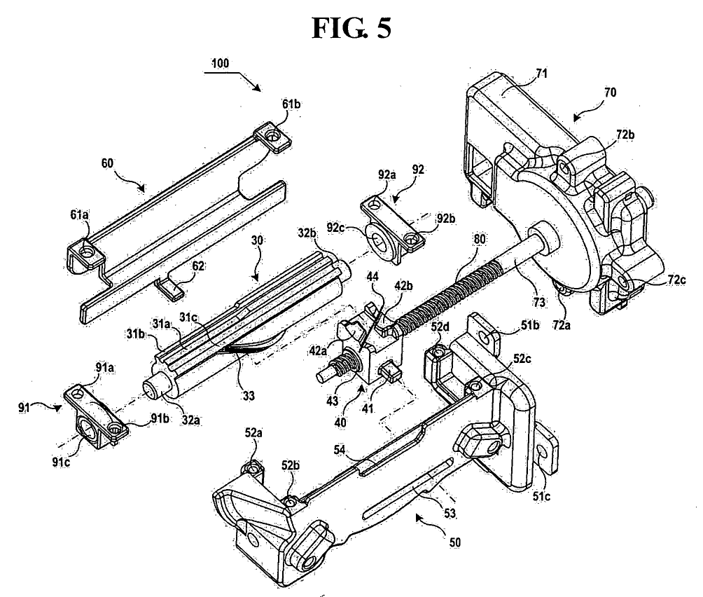

FIG. 5 is an exploded perspective view showing the lamp shield driving device 100 according to the embodiment of the present invention. The lamp shield driving device 100 may includes a cylindrical rotary shield 30, a mover 40, a receiving unit 50, a receiving unit cover 60, a step motor 70, a lead screw 80, rotary supporting parts 91 and 92. The step motor 70 and a lead screw 80 may be referred to as a driving unit.

A screw cam 33 for converting a linear motion into a rotational motion is formed on the peripheral surface of the cylindrical rotary shield 30. The relationship between the linear motion of the mover 40 and the rotational motion of the cylindrical rotary shield 30 depends on the pitch p1 of the screw cam 33. That is, the mover 40 should be moved by a distance of p1·θ1/π to rotate the cylindrical rotary shield 30 by a predetermined angle θ1. Here, the angle θ1 is represented by radian. The peripheral surface of the screw cam 33 is engaged with grooves 44 formed on the guide protrusions 42a and 42b that are provided on the upper portion of the mover 40.

Meanwhile, rotary shafts 32a and 32b are formed on both ends of the cylindrical rotary shield 30, and one or more shield protrusions 31a, 31b, and 31c are formed on the peripheral surface of the cylindrical rotary shield 30 in an axial direction thereof. Further, each of the rotary shafts 32a and 32b is supported by the rotary supporting parts 91 and 92, and is freely rotated in the rotary supporting parts 91 and 92.

As shown in FIG. 3, the shield protrusions 31a, 31b, and 31c includes a first shield protrusion 31a corresponding to the beam radiation pattern for class C, a second shield protrusion 31b corresponding to the beam radiation pattern for class E, and a third shield protrusion 31c corresponding to the beam radiation pattern for class V.

In addition, a flat portion 35 may be further formed on the peripheral surface of the cylindrical rotary shield 30 to correspond to the high beam radiation pattern so that the portion of the projection lamp on which light is focused is not shielded.

The mover 40 includes a slider 41 formed on one side surface thereof, one or more guide protrusions 42a and 42b formed on the upper surface thereof, a female thread portion 43 formed therethrough.

The female thread portion 43 is a portion that has female thread formed through the mover 40 so as to be engaged with the lead screw 80. When the lead screw 80 is rotated, the mover 40 is moved linearly due to the engagement between the female thread portion 43 and the lead screw 80. The relationship between the rotational motion of the lead screw 80 and the linear motion of the mover 40 depends on the pitch p2 of the lead screw 80. That is, the lead screw 80 should be rotated by an angle of 2π·f/p2 (radian) to move the cylindrical rotary shield 30 by a predetermined offset f.

In the end, the rotation angle θ2 of the lead screw 80, which is required to rotate the cylindrical rotary shield 30 by a predetermined angle θ1, may be calculated by the following expression on the basis of the ratio of the pitch p1 of the lead screw 80 to the pitch p2 of the screw cam 33.

θ2=θ1·p1/p2 (Expression 1)

When the rotation angle of the lead screw 80 is adjusted so as to correspond to Expression 1, any one of the shield protrusions 31a, 31b, and 31c can be positioned at the highest position. In this case, the shield protrusion positioned at the highest position forms the corresponding beam radiation pattern. In addition, when the lead screw 80 is rotated so as to position the flat portion 35 (shown in FIG. 3) in a horizontal position, it is possible to form the high beam radiation pattern.

The guide protrusions 42a and 42b are formed on the upper surface of the mover 40, and the grooves 44 are formed parallel to the screw cam 33 on the guide protrusions 42a and 42b so as to be engaged with the screw cam 33.

The slider 41 is formed on one side of the mover 40 so that the mover 40 is guided in the horizontal direction. The slider 41 is inserted into a guide slot 53 formed in the receiving unit 50.

Meanwhile, circular holes 91c and 92c are formed in the rotary supporting parts 91 and 92 so as to receive and support the rotary shafts 32a and 32b formed on both ends of the cylindrical rotary shield 30. Screw holes 91a and 91b are further formed in the rotary supporting part 91 and screw hole 92a and 92b are further formed in the rotary supporting part 92. The screw hole 91a, 91b, 92a, and 92b are used to fix the rotary supporting parts 91 and 92 to the receiving unit 50.

The receiving unit 50 includes screw holes 52a and 52b corresponding to screw holes 91a and 91b of the rotary supporting part 91, and screw holes 52c and 52c corresponding to screw holes 92a and 92b of the rotary supporting part 92. Further, the receiving unit 50 includes screw hole 51a, 51b, and 51c used to fix the step motor 70. A guide slot 53 is formed on one side surface of the receiving unit 50 and the slider 41 is inserted into the guide slot 53, so that the mover 40 is guided in the horizontal direction.

In addition, a stationary shield 54, which is provided with a notch having a predetermined height, is formed on one side surface of the receiving unit 50. When other shielding elements are not provided from the projection lamp, the stationary shield 54 basically forms the high beam radiation pattern.

When the cylindrical rotary shield 30 is received in the receiving unit 50, the receiving unit cover 60 is used as a cover closing the side of the receiving unit 50. Screw holes 61a and 61b are formed in the receiving unit cover 60 so as to correspond to the screw holes 52a and 52d of the receiving unit 50 and the screw holes 91a and 92a of the rotary supporting parts 91 and 92. Further, a protrusion 62 is formed in the receiving unit cover 60 so as to be fitted to the receiving unit 50.

The step motor 70 rotates the lead screw 80, which is directly coupled with a driving shaft 73 in an axial direction, as much as a user requests.

In general, a step motor is advantageous to accurately control a rotation angle as compared to an AC servo motor or DC servo motor. The step motor is a device for converting digital pulses into a mechanical motion of a shaft, and the pulses are supplied to the motor by a digital source. The shaft of the motor is rotated by a predetermined angle on the basis of the number of pulses. When the interval of the pulses is appropriately adjusted, it is possible to control the driving pattern of the motor and rotational speed of the shaft. However, other driving units, such as a servo motor or linear motor (in this case, it is unnecessary to convert the linear motion into the rotational motion by using the screw and female threads), instead of the step motor may be used in the embodiment of the present invention.

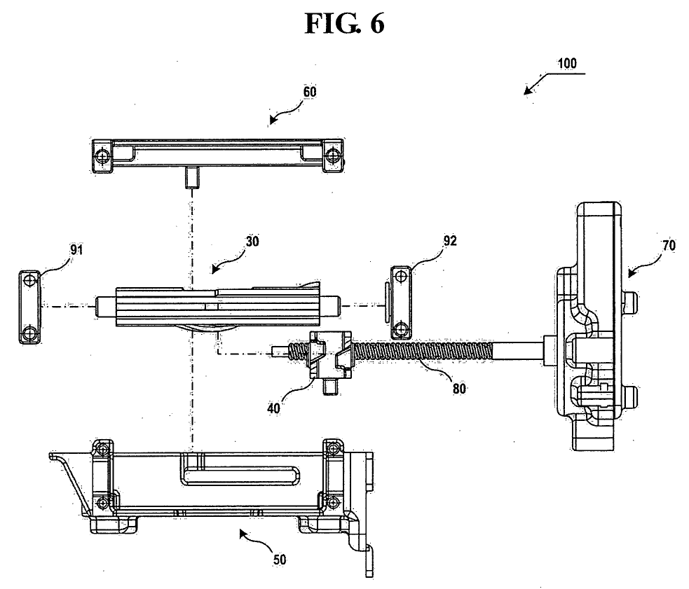

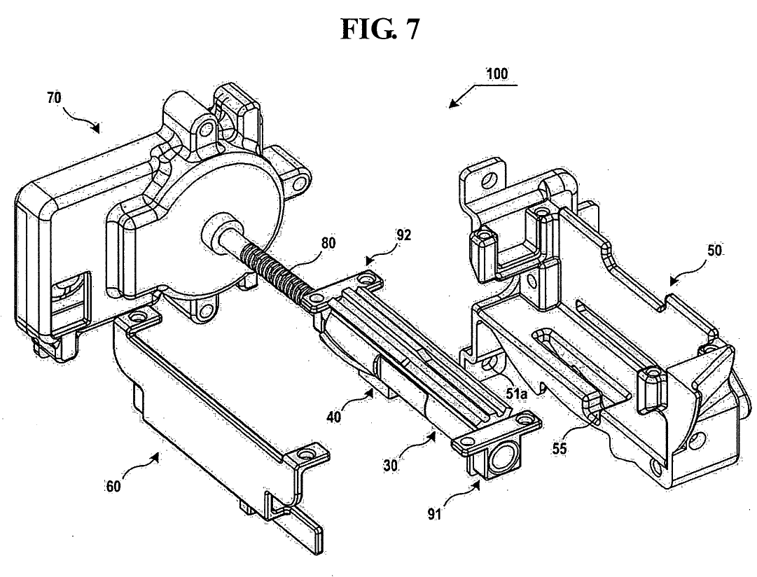

FIG. 6 is a plan view of the lamp shield driving device 100 shown in FIG. 5, as seen from above. FIG. 7 is another perspective view of the lamp shield driving device 100 shown in FIG. 5. According to the lamp shield driving device 100 shown in FIG. 7, both rotary shafts of the cylindrical rotary shield 30 are coupled with the rotary supporting parts 91 and 92, and the screw cam 33 of the cylindrical rotary shield 30 is coupled with the mover 40. When the lamp shield driving device is assembled, the protrusion 62 shown in FIG. 5 is inserted into a groove 55 formed in the receiving unit 50 shown in FIG. 7.

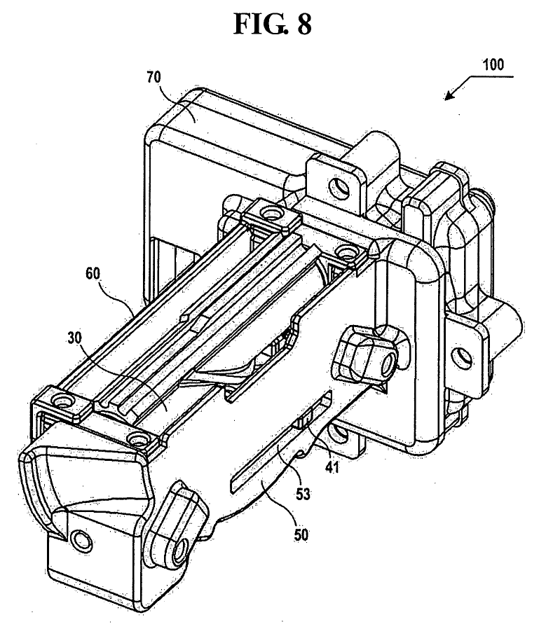

FIG. 8 is a perspective view of the lamp shield driving device shown in FIG. 5 when the lamp shield driving device is completely assembled. When the lead screw 80 is rotated by a predetermined angle, the slider 41 is horizontally moved along the guide slot 53. For this reason, the cylindrical rotary shield 30 is rotated by an angle corresponding to the motion of the slider 41. As a result, it is possible to provide a beam radiation pattern by using an appropriate shield protrusion. In this case, the projection lamp (not shown) is positioned behind the receiving unit cover 60.

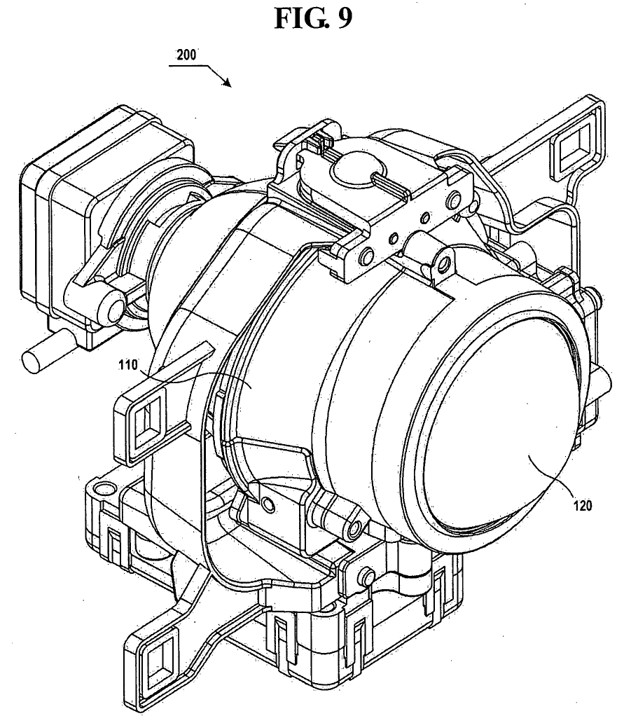

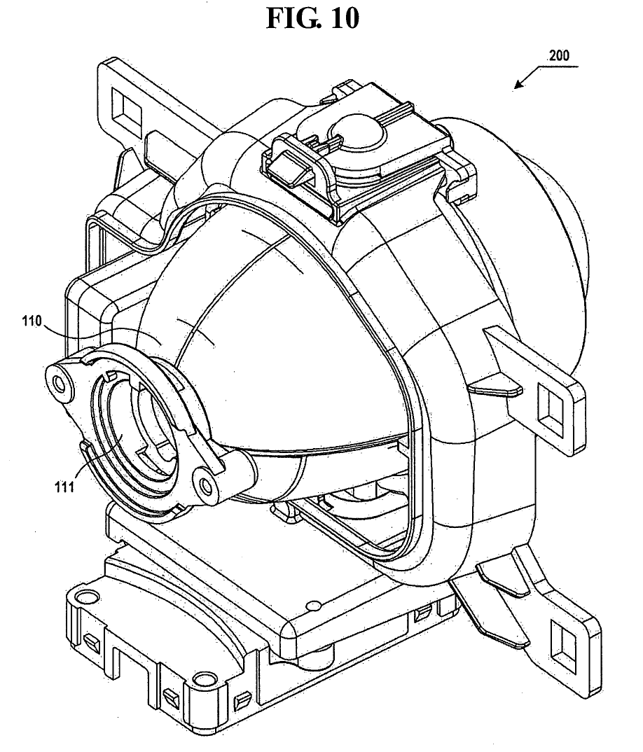

FIG. 9 is a view showing a lamp assembly 200 in which the lamp shield driving device 100 shown in FIG. 8 is received in a housing 110 and a lens 120 is mounted. The lens 120 is a refractive lens that is mounted at the front of the lamp shield driving device 100 shown in FIG. 8, and functions to increase the intensity of light emitted from the lamp.

FIG. 10 is a perspective view of the lamp assembly 200 shown in FIG. 9, as seen from the rear side of the lamp assembly. A lamp hole 111 into which the projection lamp is inserted is formed at the rear of the housing 110 of the lamp assembly 200. When the projection lamp is inserted into the lamp hole 111, the lamp assembly 200 is completely assembled.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects.

According to the embodiment of the present invention, it is possible to change the beam radiation pattern so as to correspond to various driving conditions of a vehicle and to allow a driver to ensure a visual range corresponding to various road conditions. As a result, it is possible to secure the safety while a vehicle runs.

What is claimed is:

1. A lamp assembly comprising:
a lamp;
a lamp shield driving device partially blocking light emitted from the lamp to form a beam radiation pattern;
a lens forward focusing the blocked light; and
a housing receiving the lamp and the lamp shield driving device;
wherein the lamp shield driving device comprises:
a cylindrical rotary shield including one or more shield protrusions with a predetermined cutoff pattern and a screw cam with a predetermined pitch, on a peripheral surface thereof,
a mover including a guide protrusion, which is engaged with the screw cam, on an upper surface thereof, and
a driving unit linearly moving the mover in an axial direction of the cylindrical rotary shield, and
the cylindrical rotary shield is rotated due to the linear motion of the mover, so that one of the shield protrusions is activated.

2. The lamp assembly of claim 1, further comprising:
a stationary shield having a notch with a predetermined height; and
a receiving unit including the cylindrical rotary shield.

3. The lamp assembly of claim 1, wherein:
the driving unit comprises a step motor rotating a driving shaft at a predetermined angle, and a lead screw directly coupled with the driving shaft in an axial direction;
the mover further comprises a female thread portion that is formed through the mover and engaged with the lead screw; and
the mover is linearly moved due to the rotation of the lead screw.

4. The lamp assembly of claim 2, wherein:
a slider is provided on one side surface of the mover; and
the receiving unit further comprises a guide slot into which the slide is inserted so that the mover is guided in a horizontal direction.

5. The lamp assembly of claim 2, further comprising rotary supporting parts supporting rotary shafts that are formed on both ends of the cylindrical rotary shield.

6. The lamp assembly of claim 1, wherein the cutoff pattern forms one of a beam radiation pattern for class C, beam radiation pattern for class E, and beam radiation pattern for class V.

7. The lamp assembly of claim 1, wherein:
the cylindrical rotary shield further comprises a flat portion on the peripheral surface thereof; and
when the cylindrical rotary shield is rotated so as to position the flat portion in a horizontal position, a high beam radiation pattern is formed.

8. A lamp shield driving device comprising:
a cylindrical rotary shield including one or more shield protrusions and a screw cam on a peripheral surface thereof, each of the shield protrusions having a predetermined cutoff pattern, and a screw cam having a predetermined pitch;
a mover including a guide protrusion on an upper surface thereof, the guide protrusion being engaged with the screw cam; and
a driving unit linearly moving the mover in an axial direction of the cylindrical rotary shield,
wherein the cylindrical rotary shield is rotated due to the linear motion of the mover, so that one of the shield protrusions is activated.
